(19) United States
(12) Patent Application Publication
(10) Pub. No.: US 2009/0087525 A1
(43) Pub. Date: Apr. 2, 2009

(54) MANUFACTURING OF POLYSACCHARIDE BASED NUTRITIONAL SUPPLEMENT

(76) Inventor: Ogushi Kinsen, Kumamoto (JP)

Correspondence Address: LEONG C LEI, PMB # 1008, 1867 YGNACIO VALLEY ROAD, WALNUT CREEK, CA, 94598, US

(21) Appl. No.: 11/863,296

(22) Filed: Sep. 28, 2007

(51) Int. Cl. A23L 1/30; A23L 1/302; A23L 1/304

(52) U.S. Cl. 426/285

(57) ABSTRACT

A polysaccharide based nutritional supplement is made of raw materials including agaricus powder, ganoderma powder, ganoderma lucidum natural mushroom powder, yeast, soy isoflavone, water, alcohol, minerals, vitamins, and milk sugar that are uniformly mixed with appropriate proportions and then mixed with a liquid mixture of water and alcohol in appropriate proportions to carry out mincing and mixing/stirring operation, followed by slow drying to convert the powders into dried pellets, which are then subjected to sizing/shaping operation to form uniformly-sized particles. The uniformly-sized particles are then coated with bacillus subtilis natto extract powder and sugar ester in room temperature in a secondary mixing process, followed by tableting to form tablets of nutrition-intact polysaccharide based nutritional supplement.

### BACKGROUND OF TIE INVENTION

(a) Technical Field of the Invention

The present invention relates to the manufacturing of a polysaccharide based nutritional supplement, wherein agaricus powder, ganoderma powder, ganoderma lucidum natural mushroom powder, yeast, soy isoflavone, minerals, and milk sugar are used as raw materials that are uniformly mixed with appropriate proportions and then annealed with a liquid mixture of water and alcohol in appropriate proportions to make the powders become a paste like substance, followed by drying to form dried pellets, which pellets are subjected to secondary mixing with bacillus subtilis natto extract powder and sugar ester in room temperature and then processed by a tableting device to form tablets of nutrition-intact polysaccharide based nutritional supplement.

(b) Description of the Prior Art

The manufacturing of nutritional supplements is generally carried out in accordance with the requirements for different nutrition to effect supplement of the nutrition to human bodies. Using polysaccharide as nutritional supplement is commonly known to supplement nutrition to human bodies and based on the manufacturing process taken and the supply of raw material, various products and manufacturing are known, such as Taiwan Patent No. 23570, which cultivates basidiomycetes of coriolus in aqueous liquid culture medium and dries the culture so obtained, followed by extraction with aqueous solution to obtain an extraction liquid. The liquid is further processed to remove substance of a molecular weight less than 5000 to provide a purified polysaccharide. The process is generally to extract polysaccharide and there is still a need for further processing of the polysaccharide so obtained in order to form a nutritional food or supplement. Another example is disclosed in Taiwan Patent No. 1257928, which provides a method for separating polysaccharide. Apparently, it is also a method for extracting polysaccharide. The commonly known polysaccharide extraction methods, such as hot extraction or low critical solution temperature (LCST), are usually subjected to special processing conditions and require specially designed machines or tools and the passing rate of products so produced is generally variable as being controlled by various factors. Thus, conventionally, the manufacturing of polysaccharide is technology-dependent. Further, the conventional methods for manufacturing polysaccharide may, due to the constraints imposed by the processing chosen, causes undesired damage to the polysaccharide manufactured, further making the manufacturing of polysaccharide technology dependent.

With the popularization of the development and research of nutritional supplements and with the desire of modern people to seek for nutrition balance and supplement of nutrition in order to provide preventive means for modern diseases, making nutritional supplements with polysaccharide to allow for easy and low cost consumption for general consumers is still of a prosperous future market in view of the current progress of the polysaccharide based nutritional supplement/food.

### SUMMARY OF THE INVENTION

The primary purpose of the present invention is to provide a manufacturing method of polysaccharide based nutritional supplement, wherein raw materials, including agaricus powder, ganoderma powder, and ganoderma lucidum natural mushroom powder, are stirred and mixed and then dried to form tiny pellets. The tiny pellets are then mixed with bacillus subtilis natto extract powder in room temperature to provide a nutrition-intact polysaccharide material, which is then processed by a tableting device to form tablets or particles of polysaccharide based nutritional supplement. The manufacturing process is carried out in a continuous manner by using simple facility to process the raw materials so that the costs of the process are greatly reduced, while the nutrition of the supplement is maintained.

Based on the years' experience in the development of nutritional supplements and the understanding of human body's need of polysaccharide and the troubles that the current manufacturing of polysaccharide based nutritional supplement is facing, and further in view of the drawbacks of high installation cost for facility of polysaccharide based nutritional supplements and the high manufacturing cost of the polysaccharide based nutritional supplements, the present inventor developed a manufacturing method for a polysaccharide complex based nutritional supplement, wherein agaricus powder, ganoderma lucidum natural mushroom powder, ganoderma powder, yeast, milk sugar, and minerals complex are selected as raw materials, which are subjected to stirring and mixing, annealing, and drying, and are further added with vitamin complex, bacillus subtilis natto culture powder, water, and alcohol of appropriate proportions, followed by tableting to form uniform tablets of nutritional supplement product. In this way, the manufacturing process is greatly simplified and can be carried out in a continuous way to effectively improve the drawbacks of the conventional processes.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1, shows a flow chart of a manufacturing method for polysaccharide based nutritional supplement in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

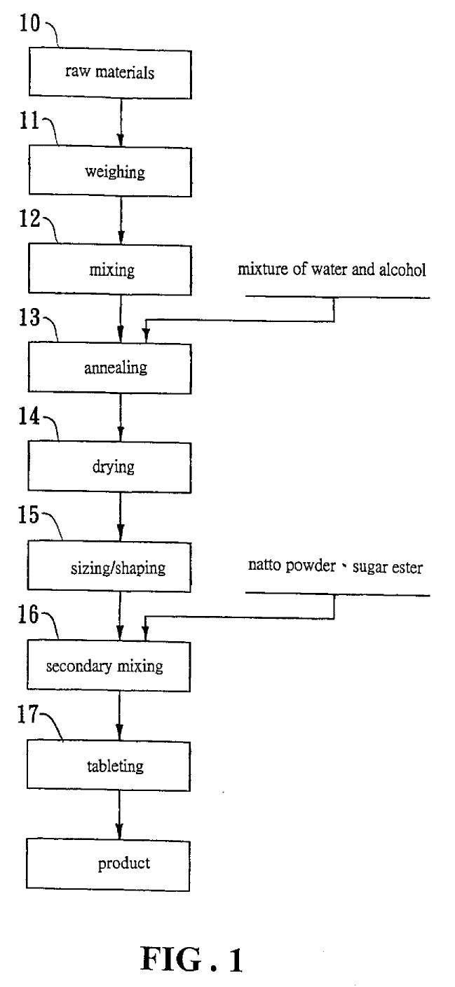

With reference to FIG. 1, the present invention provides a method for manufacturing a polysaccharide based nutritional supplement. In accordance with the present invention, the raw materials (10) for the polysaccharide based nutritional supplement comprises 10-35% agaricus powder, 8-30% ganoderma powder, 2-18% powder of ganoderma lucidum natural mushroom, less than 12% beer yeast and 4-8% powder of ganoderma extract, less than 25% minerals, 8-12% milk sugar, and vitamin C, vitamin complex, and soy isoflavone, each being less than 4%. The raw materials are weighed (11) to obtain proper amounts in accordance with the above formula and the raw materials are then positioned in a mixer for mixing (12) so that primary stiningmixing is carried out for approximately 15 minutes to provide a uniform mixture. The mixture is further mixed with a liquid mixture of water and alcohol, which are mixed in 1:1 ratio, to carry out annealing (13), which is performed for 15-30 minutes to have the previously mixed powder mixture become a substance in paste form. The paste-like substance is then deposited in a balanced drying device for slow drying (14) at a temperature around 60° C. for approximately 15 hours so that the paste-like substance becomes pellets. To ensure uniform size, the dried pellets are deposited in a sizing/shaping device for sizing and shaping (15) by high speed kneading and sieving operation to thereby obtain uniformly-sized particles having a diameter around 2.5 mm. Such particles are then deposited in a mixing chamber and less than 2% bacillus subtilis natto extract powder and less than 3% sugar ester are added in the mixing chamber in room temperature to carry out secondary mixing (16) so that the particles are coated with the bacillus subtilis natto extract powder and the sugar ester. The mixture obtained through the secondary mixing is then put into a tableting device for tableting operation (17) to obtain tablet or particle-like product of nutritional supplement.

The method for manufacturing polysaccharide based nutritional supplement does not involve any heating/refrigeration techniques, nor complicated control technique. The whole process involve only operations of simple stirring and mixing of the raw materials (10), which are provided in powder form in advance, and then adding and mixing with additional materials in the secondary mixing to provide a paste like substance that is obtained from the powder raw materials (10), which is then dried (14) to convert the paste into particles or flakes, followed by particle sizing/shaping (15) by kneading and sieving to provide uniformly-sized particles. The particles are then added with bacillus subtilis natto extract powder and sugar ester to have the particles coated with the bacillus subtilis natto extract powder and sugar ester. Then, the particles are processed by a tableting device for tableting (17) thereby forming a desired shape to facilitate consumption by the general consumer. In the manufacturing, minor amounts of bacillus subtilis natto powder, sugar ester or vitamins, yeast, soy powders are selectively added in accordance with actual requirements that set the ratio of these additives with respect to the polysaccharide. In practice, the amount of polysaccharide in a final product is set to be greater than 12% to provide the desired nutrition to human body. The process can be carried out automatically and continuously with suitably arranged facility to ensure safety and sanitary and to achieve the desired control of manufacturing. The process is carried out in room temperature and no special temperature control has to be carried out. The adding of bacillus subtilis natto powder and sugar ester is particularly limited to be done in room temperature so that a low temperature slow drying at 60° C. is employed for processing the product and no damage to the minor amount of vitamin contained in the raw materials (10) by high temperature may occur in the whole process so that the nutrition contents of the nutritional supplement can be maintained. The particle based operation allows the manufacturing line to omit refrigeration facility. Apparently, the process of the present invention is simple and the product cost is significantly reduced.

The following tables give a listing of the amount of the ingredients contained in several examples of the polysaccharide based nutritional supplement in accordance with the present invention.

### EXAMPLE 1

| Ingredients | Ratio of Ingredients (%) |
|---|---|
| Agaricus Powder (Agaricus Blazei Murill) | 20.0 |
| Calcified Seaweed (Lithothamnion Calcareum) | 20.0 |
| Ganoderma Powder (Ganoderam Lucidum) | 16.0 |
| Beer Yeast | 10.0 |
| Lactose | 10.0 |
| Ganoderma Lucidum Natural Mushroom | 8.0 |
| Ganoderma Extract (Ganoderma Lucidum) | 6.0 |
| Vitamin C | 3.0 |
| Soy Extract | 2.0 |
| Vitamin B Group | (2.0) |
| Vitamin B1 | 0.07 |
| Vitamin B2 | 0.08 |
| Vitamin B6 | 0.10 |
| Vitamin B12 | 0.00016 |
| Folic acid | 0.01 |
| Calcium Pantothenate | 0.36 |
| Niacin | 1.06 |
| Dextrin | 0.31984 |
| Sugar Ester | 2.0 |
| Bacillus Subtilis Natto Extract | 1.0 |

### EXAMPLE 2

| Ingredients | Ratio of Ingredients (%) |
|---|---|
| Agaricus Powder (Agaricus Blazei Murill) | 10.0 |
| Calcified Seaweed (Lithothamnion Calcareum) | 22.0 |
| Ganoderma Powder (Ganoderam Lucidum) | 29.0 |
| Beer Yeast | 6.0 |
| Lactose | 8.5 |
| Ganoderma Lucidum Natural Mushroom | 6.5 |
| Ganoderma Extract (Ganoderma Lucidum) | 8.0 |
| Vitamin C | 3.2 |
| Soy Extract | 2.0 |
| Vitamin B Group | (2.0) |
| Vitamin B1 | 0.07 |
| Vitamin B2 | 0.08 |
| Vitamin B6 | 0.10 |
| Vitamin B12 | 0.00016 |
| Folic Acid | 0.01 |
| Calcium Pantothenate | 0.36 |
| Niacin | 1.06 |
| Dextrin | 0.31984 |
| Sugar Ester | 2.8 |
| Bacillus Subtilis Natto Extract | 1.0 |

### EXAMPLE 3

| Ingredients | Ratio of Ingredients (%) |
|---|---|
| Agaricus Powder (Agaricus Blazei Murill) | 35.0 |
| Calcified Seaweed (Lithothamnion Calcareum) | 10.0 |
| Ganoderma Powder (Ganoderam Lucidum) | 9.0 |
| Beer Yeast | 9.0 |
| Lactose | 9.0 |
| Ganoderma Lucidum Natural Mushroom | 13.5 |
| Ganoderma Extract (Ganoderma Lucidum) | 4.5 |
| Vitamin C | 2.5 |
| Soy Extract | 2.0 |
| Vitamin B Group | (2.0) |
| Vitamin B1 | 0.07 |
| Vitamin B2 | 0.08 |
| Vitamin B6 | 0.10 |
| Vitamin B12 | 0.00016 |
| Folic Acid | 0.01 |
| Calcium Pantothenate | 0.36 |
| Niacin | 1.06 |
| Dextrin | 0.31984 |
| Sugar Ester | 2.5 |
| Bacillus Subtilis Natto Extract | 1.0 |

To summarize, the present invention provides a manufacturing of polysacharide based nutritional supplement, wherein the nutritional supplement is formed by mixing together natural substances including agaricus powder, ganoderma powder, yeast and ganoderma extract, minerals, milk sugar and vitamins and soy isoflavone. These substances are subjected to mixing and stirring with appropriate amounts/ratios, annealing processing and drying, sizing, secondary mixing with substances including bacillus subtilis natto extract and sugar ester and is carried out in a continuous manner with an automatic manufacturing line to produce nutrition-intact nutritional supplement. The present invention simplifies the manufacturing process of the polysaccharide based nutritional supplement to realize reduction of manufacturing cost and supply of natural polysaccharide complex supplement and is thus a great improvement of the manufacturing of the polysaccharide based nutritional supplement.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing a polysaccharide based nutritional supplement by using raw materials including 10-35% agaricus powder, 8-30% ganoderma powder, 2-18% powder of ganodenna lucidum natural mushroom, less than 12% beer yeast and 4-8% powder of ganoderma extract, less than 25% minerals, 8-12% milk sugar, and vitamin C, vitamin complex, and soy isoflavone, each being less than 4%, wherein the raw materials are subjected to processing comprising the following steps:
weighing to obtain a predetermined amount of each of the raw materials;
mixing the raw materials by depositing the amounts of the raw materials in a mixing device to carry out primary mixing for forming a uniform primary mixture of the raw materials;
annealing the uniform mixture by adding a liquid mixture formed by uniformly mixing water and alcohol to the primary mixture, followed by uniformly stirring, so as to convert the powder-like primary mixture into a paste like substance;
drying the paste like substance by positioning the paste like substance in a balanced drying device and carrying out slow drying at a predetermine temperature to form dried pellets;
sizing and shaping the pellets by depositing the pellets into a sizing/shaping device that carries out high speed kneading and sieving operation on the pellets to make the pellets become uniformly-sized particles;
secondary mixing that adds less than 2% bacillus subtilis natto extract powder and less than 3% sugar ester to a mixing chamber, in which the sized particles are deposited and carries out stirring and mixing to have the dried and sized particles uniformly coated with the bacillus subtilis natto extract powder and the sugar ester, thereby providing semi-finished particles; and
tableting the semi-finished particles by depositing the semi-finished particles into a tableting device for tableting operation and thus providing a size/shape consistent product of polysaccharide based nutritional supplement.

2. The method as claimed in claim 1, wherein the liquid mixture used in the annealing step is formed by mixing water and alcohol in 1:1 ratio.

3. The method as claimed in claim 1, wherein the predetermined temperature for carrying out the slow drying operation is around 60° C.

4. The method as claimed in claim 1, wherein the uniformly-sized particles obtained in the sizing step has a diameter of 2.5 mm.

5. The method as claimed in claim 1, wherein the yeast of the raw materials comprises beer yeast.
